(19) United States
(12) Patent Application Publication
(10) Pub. No.: US 2025/0189615 A1
(43) Pub. Date: Jun. 12, 2025

(54) POSITIONING SYSTEM

(71) Applicant: TOYOTA JIDOSHA KABUSHIKI KAISHA, Toyota-shi (JP)

(72) Inventors: Takayoshi YAMAZAKI, Miyoshi-shi (JP); Go Hayashi, Toyota-shi (JP); Makoto Ishii, Kunitachi-shi (JP)

(73) Assignee: TOYOTA JIDOSHA KABUSHIKI KAISHA, Toyota-shi (JP)

(21) Appl. No.: 18/882,097

(22) Filed: Sep. 11, 2024

(30) Foreign Application Priority Data
Sep. 15, 2023 (JP) 2023-150057

(51) Int. Cl. G01S 5/00; H04W 4/02; H04W 84/12

(52) U.S. Cl. CPC G01S 5/017; H04W 4/023; H04W 84/12

(57) ABSTRACT

The positioning system includes a first module that acquires information for calculating the positional relationship between a first oscillating body and a target, a second module that acquires information for calculating the positional relationship between the first oscillating body and the target with higher accuracy than the first module, and a first computing device. When the first communication device provided in the second module and the second communication device attached to the target are not within a direct communication range, the first computing device calculates the positional relationship between the first oscillating body and the target using information acquired by the first module. When the first communication device and the second communication device are within a range where they can directly communicate, the first computing device calculates the positional relationship between the first oscillating body and the target using information acquired by the second module.

### CROSS REFERENCE TO THE RELATED APPLICATION

This application claims the benefit of Japanese Patent Application No. 2023-150057, filed on Sep. 15, 2023, which is hereby incorporated by reference herein in its entirety.

### BACKGROUND

### Technical Field

The present disclosure relates to positioning systems.

### Description of the Related Art

Japanese Patent Application Laid-Open No. 2022-145143 discloses a position measuring device that measures the position of a vehicle. The positioning device disclosed in Japanese Patent Application Laid-Open No. 2022-145143 performs a first control related to reception of first information that is transmitted from an artificial satellite and is used to measure the position of a vehicle. The positioning device also performs second control regarding reception of second information transmitted from the sensor and used to measure the position of the vehicle. Then, the positioning device determines whether to perform at least one of the first control and the second control depending on the reception status of the first information and the second information.

Japanese Patent Application Laid-Open No. 2022-013929 discloses a positioning method. The positioning method disclosed in Japanese Patent Application Laid-Open No. 2022-013929 includes locating a moving body using a first positioning algorithm based on positioning data collected by at least one first sensor to obtain a first positioning result. The positioning method also includes positioning the mobile object utilizing a second positioning algorithm based on the positioning data collected by the at least one second sensor to obtain a second positioning result. The positioning method also includes determining whether the current situation of the moving object satisfies a preset switching condition during the process of determining one of the first positioning result and the second positioning result as the confirmed positioning result. The positioning method includes determining, when it is determined that the current state of the moving object satisfies the preset switching condition, the other of the first positioning result and the second positioning result as the determined positioning result.

Japanese Patent Laid-Open No. 2005-207831 discloses a posture detection device that detects a change in posture of a two-wheeled vehicle based on a GPS signal. The attitude detection device disclosed in Japanese Patent Laid-Open No. 2005-207831 includes a first GPS receiver provided at a first position on the vehicle and a second GPS receiver provided at a second position lower than the first position. The attitude detection device also determines first position information based on a GPS signal detected by the first GPS receiver, and determines second position information based on a GPS signal detected by the second GPS receiver. The attitude detection device detects the traveling direction of the vehicle, and detects a change in the attitude of the vehicle based on the first and second position information and the traveling direction of the vehicle.

Japanese Patent Laid-Open No. 2008-298443 discloses a multipath detection device that detects whether multipath waves are included in each carrier wave transmitted from each GPS satellite and received by each GPS antenna in a mobile body in which multiple GPS antennas are installed with the relative positions between the GPS antennas fixed. The multipath detection device disclosed in Japanese Patent Laid-Open No. 2008-298443 inputs carrier phase information indicating the distance between each GPS satellite and each GPS antenna in terms of the number of carrier waves, and uses a CPU to calculate the difference in carrier phase between the same GPS satellite and the GPS antennas based on the input carrier phase information.

The multipath detection device inputs the calculated carrier phase difference between the GPS antennas and a Line Of Sight (LOS) vector indicating the direction from a specific GPS antenna to a specific GPS satellite specified by an arbitrary method, and uses a CPU to calculate a baseline length indicating the distance between the GPS antennas as an observation baseline length based on the input carrier phase difference and the input LOS vector. The multipath detection device uses a CPU to compare a known baseline length, which indicates a pre-calculated distance between GPS antennas, with the observed baseline length, and if the observed baseline length differs from the known baseline length by more than a predetermined threshold value, determines that multipath waves are included in each carrier wave used to calculate the observed baseline length.

### SUMMARY

An object of the present disclosure is to grasp the positional relationship between an oscillating body and a target.

A positioning system, according to the present disclosure, comprises a first module that acquires information for calculating a positional relationship between a first oscillating body and a target, a second module that acquires information for calculating a positional relationship between the first oscillating body and the target with higher accuracy than the first module, and a first computing device, wherein the second module has a first communication device, the first communication device is configured to be able to communicate directly with a second communication device attached to the target, and the first computing device calculates the positional relationship between the first oscillating body and the target using the information acquired by the first module, when the first communication device and the second communication device are not within a range capable of direct communication, and the first computing device calculates the positional relationship between the first oscillating body and the target using the information acquired by the second module, the information including specific information related to the position of the target received by the first communication device from the second communication device, when the first communication device and the second communication device are within a range capable of direct communication.

According to the present disclosure, the positional relationship between the oscillating body and the target can be grasped.

### BRIEF DESCRIPTION OF THE DRAWINGS

FIG. 1 is a diagram showing a schematic configuration of a positioning system;

FIG. 2 is a diagram showing an example of changes in the positions of the antennas and the predetermined points when the ship and the power plant are oscillating;

FIG. 3 is a diagram showing the positional relationship between a first predetermined point on the ship and a second predetermined point on the power plant;

FIG. 4 is a block diagram illustrating an example of a functional configuration of a first computing device and a second computing device that configure the positioning system; and

FIG. 5 is a flowchart of information processing executed by the controller in the first computing device.

### DESCRIPTION OF THE EMBODIMENTS

Assume that the oscillating body moves. At this time, there may be a case where a target is present around the oscillating body. In this case, in order for the oscillating body to move safely, it is necessary to know the positional relationship between the moving body and the target.

When the oscillating body is located close to the target, it is necessary to grasp the positional relationship with higher accuracy in order to ensure safety, compared to when the oscillating body is located far from the target. On the other hand, when the oscillating body is located far from the target, it is expected that there is no need to grasp the positional relationship with high accuracy compared to when the oscillating body is located close to the target. Furthermore, in order to constantly grasp the positional relationship with high accuracy, it becomes necessary to perform advanced calculations, etc., which is expected to increase the load on the computing device. Therefore, it is assumed that it is not always necessary to calculate the positional relationship between the oscillating body and the target with high accuracy.

The positioning system according to the present disclosure is a system including a first module and a second module. Here, the first module is a module that acquires information for calculating the positional relationship between the oscillating body (hereinafter sometimes referred to as the “first oscillator”) and the target. The second module is a module that acquires information for calculating the positional relationship between the first oscillating body and the target with higher accuracy than the first module. The second module also includes a first communication device. The first communication device is configured to be able to communicate directly with a second communication device attached to the target.

In a positioning system, when the first communication device is not within a range where it can directly communicate with the second communication device, the first computing device calculates the positional relationship between the first oscillating body and the target using information acquired by the first module. Also, there are cases where the first communication device is within a range where it can directly communicate with the second communication device. In this case, the first computing device calculates the positional relationship between the first moving body and the target using information including information acquired by the second module and including specific information related to the position of the target received by the first communication device from the second communication device.

As described above, depending on whether or not the first communication device exists within a range that can be directly communicated with the second communication device, the first computing device uses the information acquired by the first module and the information acquired by the second module. As a result, when the first communication device is not within a range where it can directly communicate with the second communication device, i.e., when the first oscillating body and the target are far apart, the positional relationship between the first oscillating body and the target is calculated based on the information acquired by the first module. On the other hand, when the first communication device is within a range where it can directly communicate with the second communication device, i.e., when the first oscillating body and the target are in close proximity, the positional relationship between the first oscillating body and the target is calculated based on the information acquired by the second module. Therefore, when the first oscillating body and the target are located close to each other, the positional relationship between the first oscillating body and the target is switched to be calculated with higher accuracy than when the first oscillating body and the target are located far away from each other. In this way, while reducing the load and the like related to the first computing device, it is possible to grasp the positional relationship between the first moving body and the target.

Hereinafter, specific embodiments of the present disclosure will be described with reference to the drawings. Unless otherwise specified, the hardware configuration, module configuration, functional configuration, and the like described in each embodiment are not intended to limit the technical scope of the disclosure to only those.

### First Embodiment

### (System Overview)

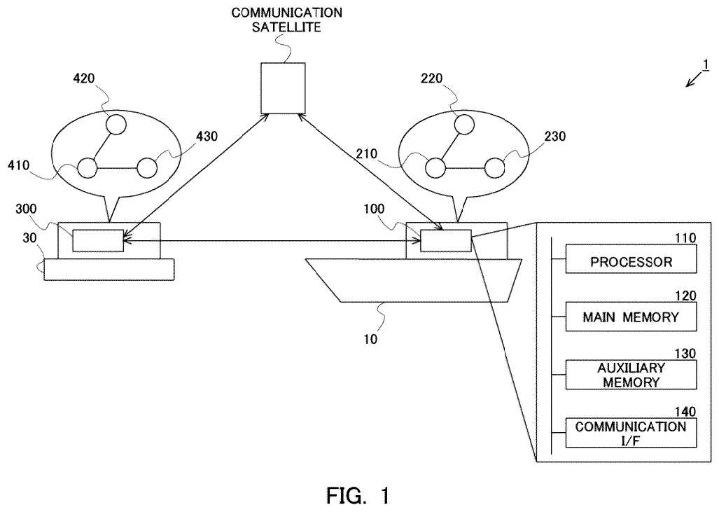

A positioning system 1 according to the present embodiment will be described with reference to FIG. 1. FIG. 1 is a diagram showing a schematic configuration of a positioning system 1. The positioning system 1 includes a first computing device 100, a first antenna 210, a second antenna 220, and a third antenna 230, as well as a second computing device 300, a fourth antenna 410, a fifth antenna 420, and a sixth antenna 430. In the positioning system 1, a first antenna 210, a second antenna 220, and a third antenna 230 are connected to a first computing device 100. In addition, in the positioning system 1, a fourth antenna 410, a fifth antenna 420, and a sixth antenna 430 are connected to the second computing device 300.

Moreover, the first computing device 100 and the second computing device 300 are configured to be capable of short-range communication. The first computing device 100 and the second computing device 300 communicate directly with each other via Wi-Fi (registered trademark), for example. The first computing device 100 and the second computing device 300 may communicate directly with each other via Bluetooth (registered trademark), for example. Thus, since the first computing device 100 and the second computing device 300 exist at sea, even if a telephone communication network such as a mobile phone cannot be used, the first computing device 100 and the second computing device 300 can communicate by wireless LAN. In this case, the first computing device 100 and the second computing device 300 start direct communication when the first computing device 100 and the second computing device 300 are within a communication range.

In addition, even if the first computing device 100 and the second computing device 300 cannot communicate directly with each other via Wi-Fi, they can communicate over a wide area using satellite communication via a communication satellite. In addition, the first computing device 100 and the second computing device 300 may be configured to be able to communicate via wide area communication such as VHF communication or a telephone communication network such as a mobile phone when direct communication via Wi-Fi is not possible, in addition to satellite communication.

Here, it is expected that a communication lag will occur when the first computing device 100 and the second computing device 300 communicate via satellite communication compared to when they communicate directly via Wi-Fi. Furthermore, it is expected that the amount of communication traffic will be smaller when the first computing device 100 and the second computing device 300 communicate via satellite communication than when they communicate directly via Wi-Fi. Therefore, when the first computing device 100 communicates with the second computing device 300 via satellite communication, it is conceivable that the first computing device 100 will communicate smaller volume data with a lag than when communicating directly.

### (Antenna)

The first antenna 210, the second antenna 220, and the third antenna 230 are positioning antennas attached to the ship 10. The first antenna 210, the second antenna 220, and the third antenna 230 are, for example, GNSS positioning antennas. The first antenna 210, the second antenna 220, and the third antenna 230 can measure the current positions of the first antenna 210, the second antenna 220, and the third antenna 230. The current positions measured by the first antenna 210, the second antenna 220, and the third antenna 230 are, for example, their respective latitude, longitude, and altitude.

The fourth antenna 410, the fifth antenna 420, and the sixth antenna 430 are positioning antennas attached to the power plant 30. The fourth antenna 410, the fifth antenna 420, and the sixth antenna 430 are also, for example, GNSS positioning antennas. The fourth antenna 410, the fifth antenna 420, and the sixth antenna 430 can measure the current positions of the fourth antenna 410, the fifth antenna 420, and the sixth antenna 430. The current positions measured by the fourth antenna 410, the fifth antenna 420, and the sixth antenna 430 are also, for example, latitude, longitude, and altitude, respectively.

In this embodiment, the first antenna 210, the second antenna 220, and the third antenna 230 are attached to the upper surface of the ship 10. In addition, the fourth antenna 410, the fifth antenna 420, and the sixth antenna 430 are attached to the top surface of the power plant 30. This makes it possible to prevent the first antenna 210, the second antenna 220, the third antenna 230, and the fourth antenna 410, the fifth antenna 420, and the sixth antenna 430 from being unable to receive radio waves from the GNSS satellites. It should be noted that the first antenna 210, the second antenna 220, and the third antenna 230 do not necessarily have to be mounted horizontally on the ship 10. Furthermore, the fourth antenna 410, the fifth antenna 420, and the sixth antenna 430 do not necessarily have to be mounted horizontally in the power plant 30.

Here, since the ship 10 is a ship, it oscillates due to the influence of ocean waves, wind, and the like. In this embodiment, the power plant 30 is a floating offshore wind power plant. Therefore, the power plant 30 oscillates due to the influence of ocean waves and wind, etc.

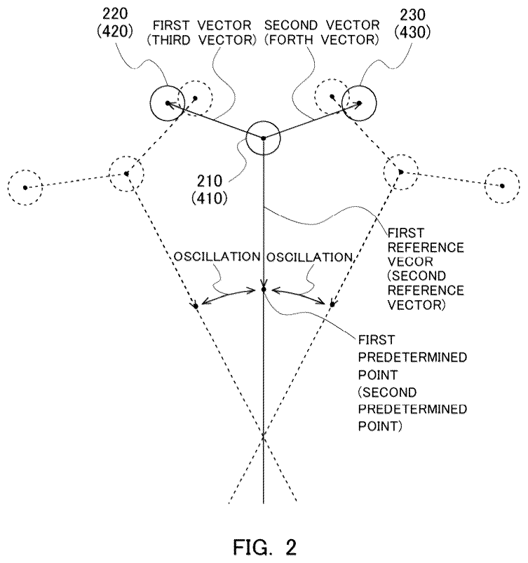

FIG. 2 is a diagram showing an example of changes in the positions of the antennas and the predetermined points when the ship 10 and the power plant 30 are oscillating. FIG. 2 shows how the current position of the first antenna 210, the current position of the second antenna 220, and the current position of the third antenna 230 (hereinafter, these may be referred to as the “first position,” the “second position,” and the “third position,” respectively) change due to the oscillation of the ship 10. In FIG. 2, the first antenna 210, the second antenna 220, the third antenna 230, the first vector (described later), the second vector (described later), and the first reference vector (described later) are drawn in solid lines when the ship 10 is not oscillating. In addition, in FIG. 2, the first antenna 210, the second antenna 220, the third antenna 230, the first vector, the second vector, and the first reference vector when the ship 10 is oscillating are drawn by dashed lines. As shown in FIG. 2, the first position, the second position, the third position, and the first predetermined predetermined point change as the ship 10 oscillates.

As shown in FIG. 2, the current position of the fourth antenna 410 (fourth position), the current position of the fifth antenna 420 (fifth position), the current position of the sixth antenna 430 (sixth position), the third vector (described later), the fourth vector (described later), and the second reference vector (described later) also change as the power plant 30 oscillates.

### (Second Computing Device)

The second computing device 300 is a device that acquires the current positions of the fourth antenna 410, the fifth antenna 420, and the sixth antenna 430 in the power plant 30. The second computing device 300 acquires from the fourth antenna 410 the current position (fourth position) of the fourth antenna 410 measured by the fourth antenna 410. In addition, the second computing device 300 acquires the current position (fifth position) of the fifth antenna 420 measured by the fifth antenna 420 from the fifth antenna 420. In addition, the second computing device 300 acquires the current position (sixth position) of the sixth antenna 430 measured by the sixth antenna 430 from the sixth antenna 430. Then, the second computing device 300 communicates with the first computing device 100 to transmit specific information including the fourth position, the fifth position, and the sixth position to the first computing device 100.

### (First Computing Device)

The first computing device 100 is a device that calculates the position (latitude, longitude, and altitude) of a first predetermined point on the ship 10. Here, the first predetermined point is an arbitrary point of the ship 10. The first predetermined point is, for example, a point on the surface of the ship 10. The first predetermined point may also be an internal point such as the center of gravity or center of buoyancy of the ship 10. Furthermore, the ship 10 may move around the power plant 30 by traveling on the ocean.

The first computing device 100 acquires from the first antenna 210 the current position (first position) of the first antenna 210 measured by the first antenna 210. In addition, the first computing device 100 acquires the current position (second position) of the second antenna 220 measured by the second antenna 220 from the second antenna 220. In addition, the first computing device 100 acquires the current position (third position) of the third antenna 230 measured by the third antenna 230 from the third antenna 230.

The first computing device 100 calculates a first vector and a second vector. Here, the first vector is a vector from the first position to the second position. Moreover, the second vector is a vector from the first position to the third position. Then, the first computing device 100 calculates the current attitude of the ship 10 at the first position using the first vector and the second vector. Specifically, the first computing device 100 calculates the roll, pitch, and yaw of the first position.

Here, a first reference vector is predefined for a first predetermined point on the ship 10. The first reference vector is a vector from the first antenna 210 to the first predetermined point in an attitude of the ship 10 at predetermined time. Here, the attitude at the predetermined time is, for example, the posture at a time when the ship 10 is not oscillating. In other words, the attitude at the predetermined time is the attitude when the roll, pitch, and yaw in the first position are zero. The first computing device 100 corrects the first reference vector according to the current attitude of the ship 10 at the first position (the current attitude including the roll, pitch, and yaw at the first position). Then, the first computing device 100 calculates the position of the first predetermined point using the corrected first predetermined point vector and the first position.

Furthermore, the first computing device 100 communicates with the second computing device 300 to receive specific information from the second computing device 300. The first computing device 100 calculates the position of the second predetermined point of the power plant 30 from the fourth position, the fifth position, and the sixth position in the same manner as it calculates the position of the first predetermined point from the first position, the second position, and the third position. Here, the second predetermined point is an arbitrary point of the power plant 30. The second predetermined point is, for example, a point on the surface of the power plant 30. The second predetermined point may also be an internal point, such as the center of gravity or center of buoyancy of the power plant 30, for example.

Specifically, the first computing device 100 calculates a third vector and a fourth vector, and calculates the current attitude of the power plant 30 at the fourth position. Here, the third vector is a vector from the fourth position to the fifth position. Moreover, the fourth vector is a vector from the fourth position to the sixth position. A second reference vector is also predefined for a second predetermined point of the power plant 30. The second reference vector is a vector from the fourth antenna 410 to a second predetermined point at the predetermined attitude of the power plant 30 at that time. Here, the posture at a given time is, for example, the posture at a time when the power plant 30 is not oscillating. The first computing device 100 corrects the second reference vector in accordance with the current attitude of the power plant 30 at the fourth position, and calculates the position of the second predetermined point. The method by which the first computing device 100 corrects the first reference vector (second reference vector) and the method by which the first computing device 100 calculates the position of the first predetermined point (second predetermined point) will be described in detail later.

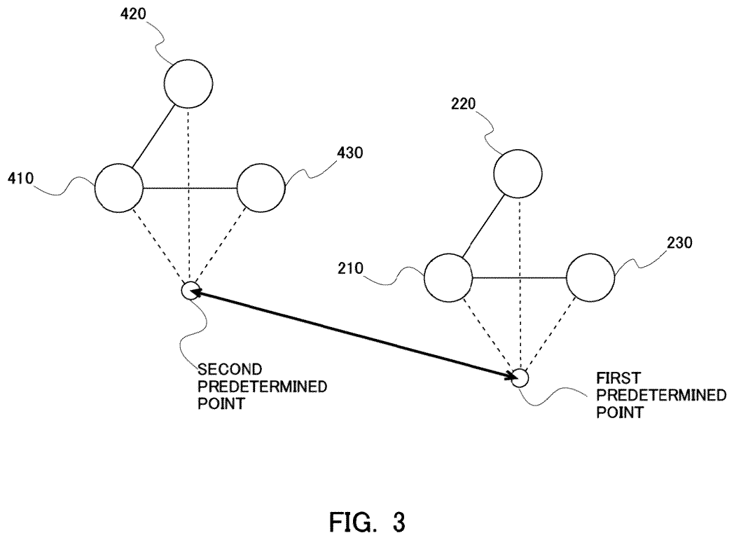

FIG. 3 is a diagram showing the positional relationship between a first predetermined point on the ship 10 and a second predetermined point on the power plant 30. FIG. 3 shows the position of a first predetermined point calculated from the first position, second position, and third position acquired by the first antenna 210, the second antenna 220, and the third antenna 230, and the position of a second predetermined point calculated from the fourth position, fifth position, and sixth position acquired by the fourth antenna 410, the fifth antenna 420, and the sixth antenna 430. The first computing device 100 calculates the positional relationship between the first predetermined point and the second predetermined point from the calculated positions of the first predetermined point and the second predetermined point.

Here, the positional relationship between the first predetermined point and the second predetermined point includes, for example, the distance between the first predetermined point and the second predetermined point and the direction with the first predetermined point as the base point. Furthermore, the positional relationship between the first predetermined point and the second predetermined point may be a relative distance to the second predetermined point with the first predetermined point as a reference. Furthermore, the positional relationship between the first predetermined point and the second predetermined point may include a relative speed between the first predetermined point and the second predetermined point using the first predetermined point as a reference. In this case, the first computing device 100 calculates the relative speed between the first predetermined point and the second predetermined point by calculating the time transition of the relative distance between the first predetermined point and the second predetermined point. The positional relationship between the first predetermined point and the second predetermined point may include a relative distance, a direction, and a relative speed based on the second predetermined point.

On the other hand, in order for the first computing device 100 to receive the specific information from the second computing device 300, it is necessary for the first computing device 100 to communicate with the second computing device 300. Therefore, when the first computing device 100 directly communicates with the second computing device 300, the first computing device 100 receives the specific information. However, if the ship 10 is located in a position where the first computing device 100 and the second computing device 300 are outside the range of direct communication, the first computing device 100 cannot communicate directly with the second computing device 300. Therefore, if the first computing device 100 and the second computing device 300 are not able to communicate directly with each other, it will be impossible to calculate the positional relationship between the first predetermined point and the second predetermined point by referring to specific information.

On the other hand, the first computing device 100 and the second computing device 300 can communicate with each other via satellite communication. Then, the first computing device 100 receives the position of the power plant 30 from the second computing device 300 via satellite communication. Here, the location of the power plant 30 is obtained from the fourth antenna 410, the fifth antenna 420, and the sixth antenna 430, or other antennas, provided on the power plant 30. Then, the second computing device 300 transmits the position of the power plant 30 to the first computing device 100 via satellite communication.

When the first computing device 100 and the second computing device 300 are not able to communicate with each other, the first computing device 100 refers to the position of the power plant 30 received by satellite communication and calculates the positional relationship between them. Specifically, the first computing device 100 acquires a position (first position, second position or third position) measured by at least one of the first antenna 210, the second antenna 220, and the third antenna 230 as the current position of the ship 10. In addition, the first computing device 100 may acquire the current position of the ship 10 from an antenna other than the first antenna 210, the second antenna 220, and the third antenna 230. In addition, the first computing device 100 refers to the current position of the ship 10 and the position of the power plant 30 received by satellite communication, and calculates the positional relationship between the ship 10 and the power plant 30.

At this time, if precise positioning using a PPP (Precise Point Positioning) method is possible, the first computing device 100 may correct the current position of the ship 10 determined by GNSS positioning using this method. Furthermore, if precise positioning using the Real-Time Kinematic (RTK) method is possible, the first computing device 100 may correct the current position of the ship 10 determined using GNSS positioning using this method.

Here, as described above, the information received from the second computing device 300 is expected to have a lag and a smaller capacity than when the first computing device 100 and the second computing device 300 communicate directly. However, the ship 10 and the power plant 30 are located farther apart than the first computing device 100 and the second computing device 300 can directly communicate with each other. Therefore, even if the information about the position of the power plant 30 has a delay and is of small capacity, making it impossible to calculate the positional relationship with high accuracy, it is expected that the impact on safety will be smaller than if the ship 10 and the power plant 30 were located close to each other.

In this way, the first computing device 100 calculates the positional relationship between the ship 10 and the power plant 30 using satellite communication until the first computing device 100 is able to communicate with the second computing device 300. Then, when the ship 10 approaches the power plant 30 and the first computing device 100 is able to communicate with the second computing device 300, the first computing device 100 refers to the first position, the second position, the third position, the fourth position, the fifth position, and the sixth position to calculate the positional relationship between the first predetermined point and the second predetermined point that changes due to the oscillation. In this way, the first computing device 100 switches between a method of calculating the positional relationship with low accuracy and a method of calculating the positional relationship with high accuracy depending on the position of the power plant 30.

This allows the ship 10 to initially refer to the position of the power plant 30 received via satellite communication and approach the power plant 30. Furthermore, when the ship 10 gets sufficiently close to the power plant 30, it can move even closer to the power plant 30 while referring to the positions of the predetermined points (first predetermined point and second predetermined point) that change due to the oscillation. Here, if the first predetermined point is a point on the surface of the ship 10 and the second predetermined point is a point on the surface of the power plant 30, it is possible to calculate the distance between the surface of the ship 10 and the surface of the power plant 30. This ensures safety when the ship 10 is moving around the power plant 30.

The first computing device 100 includes a computer having a processor 110, a main memory 120, an auxiliary memory 130, and a communication interface (communication I/F) 140. The processor 110 is, for example, a central processing unit (CPU) or a digital signal processor (DSP). The main memory 120 is, for example, a RAM (Random Access Memory). The auxiliary memory 130 is, for example, a ROM (Read Only Memory). The auxiliary memory 130 is, for example, a HDD (Hard Disk Drive), or a disk recording medium such as a CD-ROM, a DVD disk, or a Blu-ray disk. The auxiliary memory 130 may be a removable medium. Here, examples of removable media include a USB memory and an SD card.

In the first computing device 100, the auxiliary memory 130 stores an operating system (OS), various programs, various information tables, and the like. Furthermore, in the first computing device 100, the processor 110 can realize various functions, which will be described later, by loading a program stored in the auxiliary memory 130 into the main memory 120 and executing it. However, some or all of the functions of the first computing device 100 may be realized by a hardware circuit such as an ASIC or an FPGA. The first computing device 100 does not necessarily have to be realized by a single physical configuration, and may be configured by a plurality of computers that work in cooperation with each other. Similarly to the first computing device 100, the second computing device 300 also includes a computer.

### (Functional Configuration)

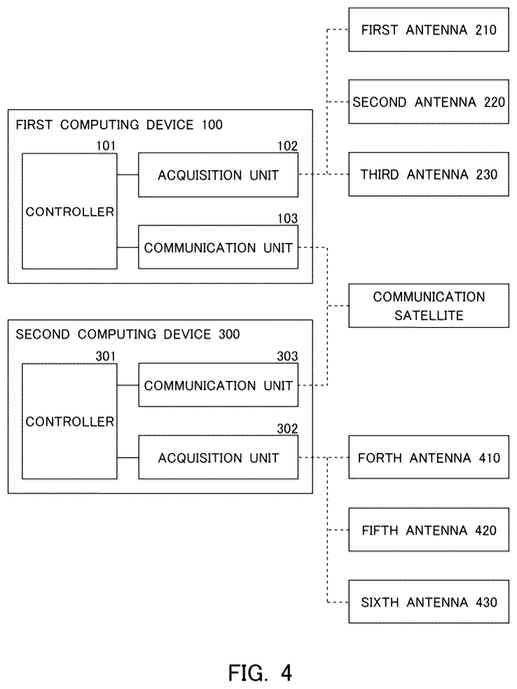

Next, the functional configuration of the first computing device 100 and the second computing device 300 that configure the positioning system 1 will be described with reference to FIG. 4. FIG. 4 is a block diagram illustrating an example of a functional configuration of the first computing device 100 and the second computing device 300 that configure the positioning system 1.

### (Second Computing Device)

The second computing device 300 includes a controller 301, an acquisition unit 302, and a communication unit 303. The controller 301 has a function of performing computing processing for controlling the second computing device 300. The controller 301 can be realized by a processor in the second computing device 300. The acquisition unit 302 has a function of acquiring the current positions from the fourth antenna 410, the fifth antenna 420, and the sixth antenna 430. The acquisition unit 302 can be realized by an interface for connecting the second computing device 300 to each antenna. The communication unit 303 has a function of communicating with the first computing device 100. The communication unit 303 can be realized by a communication I/F in the second computing device 300.

The controller 301 acquires the current positions (fourth position, fifth position, and sixth position) of the fourth antenna 410, the fifth antenna 420, and the sixth antenna 430, respectively, by the acquisition unit 302. Then, the controller 301 transmits the specific information including the fourth position, the fifth position, and the sixth position to the first computing device 100 via the communication unit 303.

In addition, the controller 301 acquires the current position of at least one of the fourth antenna 410, the fifth antenna 420, and the sixth antenna 430 as the current position of the power plant 30 via the acquisition unit 302. Then, the controller 301 transmits the current position of the power plant 30 to the first computing device 100 via satellite communication by the communication unit 303.

### (First Computing Device)

The first computing device 100 includes a controller 101, an acquisition unit 102, and a communication unit 103. The controller 101 has a function of performing computing processing for controlling the first computing device 100. The controller 101 can be realized by the processor 110 in the first computing device 100. The acquisition unit 102 has a function of acquiring the current positions from the first antenna 210, the second antenna 220, and the third antenna 230. The acquisition unit 102 can be realized by an interface for connecting the first computing device 100 and each antenna.

The communication unit 103 has a function of communicating with the second computing device 300. The communication unit 103 can be realized by the communication I/F 140 in the first computing device 100. Here, the first computing device 100 communicates directly with the second computing device 300 via the communication unit 103. In addition, the second computing device 300 performs satellite communication with the second computing device 300 via the communication unit 103.

The controller 101 acquires the current positions (first position, second position, and third position) of the first antenna 210, the second antenna 220, and the third antenna 230, respectively, by the acquisition unit 102. The controller 101 calculates a first vector using the first position and the second position. Furthermore, the controller 101 calculates a second vector using the first position and the third position. In this embodiment, each component of the first vector and the second vector is set using a coordinate system of latitude, longitude, and altitude.

When the controller 101 is able to directly communicate with the second computing device 300 via the communication unit 103, the controller 101 starts direct communication with the second computing device 300. The controller 101 determines, for example, via the communication unit 103, whether or not a Wi-Fi radio wave is being received from the second computing device 300. Then, when the controller 101 receives a Wi-Fi radio wave from the second computing device 300, the controller 101 starts communication with the second computing device 300. When the controller 101 starts direct communication with the second computing device 300, the controller 101 receives the specific information from the second computing device 300 in real time.

The controller 101 calculates the roll, pitch, and yaw of the first position using the first vector and the second vector, thereby calculating the current attitude of the ship 10 at the first position. Here, in this embodiment, the roll, pitch, and yaw of the first position are determined by angles around the latitudinal axis, the longitudinal axis, and the altitude axis with the first position as the reference (origin) using latitude, longitude, and altitude as a coordinate system. Then, the controller 101 corrects the first reference vector in accordance with the current attitude of the ship 10 at the calculated first position.

Now assume that the current attitude of the ship 10 at a first position is represented by a roll with a roll angle r, a pitch with a pitch angle p, and a yaw with a yaw angle h. The corrected first reference vector (x′, y′, z′) is expressed by the following equation using the rotation matrices for the roll angle r, pitch angle p, and yaw angle h, and the first reference vector before correction (x, y, z). Here, the first reference vector is defined by a coordinate system defined by latitude, longitude, and altitude.

$$( \begin{matrix}{x}^{′} \\ {y}^{′} \\ {z}^{′}\end{matrix} ) = ( \begin{matrix}1 & 0 & 0 \\ 0 & cos r & - s in r \\ 0 & sin r & cos r\end{matrix} ) ( \begin{matrix}cos p & & - sin p \\ 0 & 1 & 0 \\ sin p & 0 & cos p\end{matrix} ) ( \begin{matrix}cos h & - sin h & 0 \\ sin h & cos h & 0 \\ 0 & 0 & 1\end{matrix} ) ( \begin{matrix}x \\ y \\ z\end{matrix} ) \qquad ( equation 1 )$$

The corrected first reference vector (x′, y′, z′) is a vector from the first position to the current first predetermined point using the latitude, longitude, and altitude as a coordinate system. Therefore, the controller 101 calculates the current position of the first predetermined point by adding each component of the coordinates of the first position to each component of the modified first reference vector (x′, y′, z′).

The controller 101 receives the specific information including the fourth position, the fifth position, and the sixth position from the second computing device 300 through direct communication by the communication unit 103. The controller 101 calculates a third vector using the fourth position and the fifth position. Furthermore, the controller 101 calculates a fourth vector using the fourth position and the sixth position.

The controller 101 calculates the current attitude of the power plant 30 at the fourth position using the third vector and the fourth vector. The controller 101 corrects the second reference vector according to the current attitude of the power plant 30 at the calculated fourth position. Then, the controller 101 calculates the current position of the second predetermined point by adding each component of the coordinates of the fourth position to each component of the modified second reference vector. Here, the second reference vector, which is a vector from the fourth antenna 410 to the second predetermined point in an attitude of the power plant 30 at predetermined time, is grasped by the controller 101 as a given vector. Furthermore, the controller 101 may receive the second reference vector from the second computing device 300 when receiving the specific information. The method for calculating the current position of the second predetermined point using the fourth position, the fifth position, and the sixth position is similar to the method for calculating the current position of the first predetermined point using the first position, the second position, and the third position (described above), so a description thereof will be omitted.

In this embodiment, the controller 101 calculates the positional relationship between the ship 10 and the power plant 30 by calculating the positional relationship between the first predetermined point and the second predetermined point. However, the controller 101 may calculate the positional relationship between the ship 10 and the power plant 30 by calculating the positional relationship between the position of the first predetermined point and the position of the power plant 30 received by satellite communication.

In addition, when the first computing device 100 is unable to communicate directly with the second computing device 300, the controller 101 refers to the position of the power plant 30 received via satellite communication by the communication unit 103, and calculates the positional relationship between the ship 10 and the power plant 30. In this embodiment, the controller 101 calculates the positional relationship between the ship 10 and the power plant 30 by referring to the position of the power plant 30 received via satellite communication, but it may also calculate the positional relationship between the ship 10 and the power plant 30 by referring to the position of the power plant 30 that has been stored in advance.

### (Flowchart)

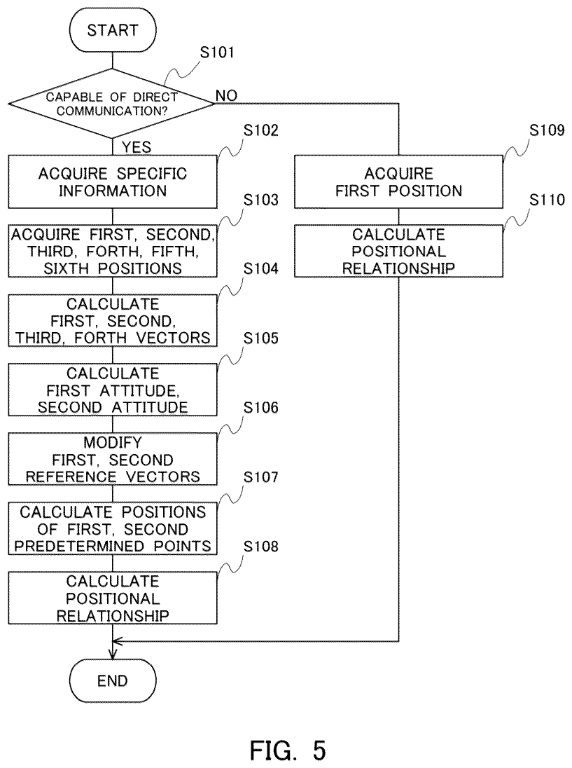

Next, information processing executed by the controller 101 in the first computing device 100 in the positioning system 1 will be described with reference to FIG. 5. FIG. 5 is a flowchart of information processing executed by the controller 101 in the first computing device 100. The information processing shown in FIG. 5 is processing for calculating the positional relationship between the ship 10 and the power plant 30. The information processing shown in FIG. 5 is repeatedly executed at predetermined intervals.

In the information processing shown in FIG. 5, first, in S101, it is determined whether or not the first computing device 100 and the second computing device 300 are capable of direct communication with each other. When the first computing device 100 and the second computing device 300 are capable of direct communication with each other, the controller 101 can receive specific information from the second computing device 300. Therefore, the controller 101 can calculate the positional relationship between the first predetermined point and the second predetermined point by referring to the first position, the second position, the third position, the fourth position, the fifth position, and the sixth position. Therefore, if a positive determination is made in S101, the specific information received from the second computing device 300 is acquired in S102. Next, in S103, the first position, the second position, and the third position are obtained from the first antenna 210, the second antenna 220, and the third antenna 230. In addition, in S103, the fourth position, the fifth position, and the sixth position are obtained from the specific information. Next, in S104, a first vector and a second vector are calculated using the first position, the second position, and the third position. In addition, in S104, a third vector and a fourth vector are calculated using the fourth position, the fifth position, and the sixth position.

Next, in S105, the attitude of the ship 10 at the first position is calculated using the first vector and the second vector. In addition, in S105, the attitude of the power plant 30 at the fourth position is calculated using the third vector and the fourth vector. Next, in S106, the first reference vector is corrected using the attitude of the ship 10 at the first position. Also, in S106, the second reference vector is corrected using the attitude of the power plant 30 at the fourth position.

Next, in S107, the position of the first predetermined point is calculated using the corrected first vector and the first position. Further, in S107, the position of the second predetermined point is calculated using the modified second vector and the fourth position. Next, in S108, the positional relationship between the first predetermined point and the second predetermined point is calculated using the positions of the first predetermined point and the second predetermined point calculated in S107. Then, the process shown in FIG. 5 is temporarily terminated.

Moreover, if a negative determination is made in S101, the specific information cannot be acquired. Then, in S109, the first position is obtained from the first antenna 210. Next, in S110, the positional relationship between the ship 10 and the power plant 30 is calculated by referring to the first position and the position of the power plant 30 received by satellite communication. Then, the process shown in FIG. 5 is temporarily terminated.

As described above, when the first computing device 100 and the second computing device 300 are not able to communicate directly, the first computing device 100 calculates the positional relationship between the ship 10 and the power plant 30 by referring to the first position and the position of the power plant 30 received via satellite communication. In addition, when the first computing device 100 and the second computing device 300 are capable of direct communication, the first computing device 100 calculates the positional relationship between the first predetermined point and the second predetermined point by referring to the first position, the second position, the third position, the fourth position, the fifth position, and the sixth position.

In this way, when the ship 10 approaches the power plant 30, the first computing device 100 first calculates the position obtained by the antenna installed on the ship 10, the position of the power plant 30 received via satellite communication, and the positional relationship between the ship 10 and the power plant 30. Then, when ship 10 is present within the direct communication range between the first computing device 100 and the second computing device 300, the first computing device 100 calculates the positional relationship between the first predetermined point and the second predetermined point by referring to the first position, the second position, the third position, the fourth position, the fifth position, and the sixth position. In this way, it is possible to grasp the positional relationship between the ship 10 and the power plant 30 regardless of the position of the ship 10.

### Variation 1

In this embodiment, the coordinate system used for the (first and second) reference vectors is a latitude, longitude and altitude coordinate system. However, the coordinate system used for the reference vectors may be other than that defined by latitude, longitude, and altitude. For example, it may be a coordinate system in the direction of travel of the ship 10, the lateral direction of the ship 10, and the upward direction of the ship 10, etc. It may also be, for example, a coordinate system in the forward direction of the power plant 30, the lateral direction of the power plant 30, and the upward direction of the power plant 30. Furthermore, the coordinate system used for the attitude, etc. of the ship 10 (power plant 30) may be a coordinate system different from the coordinate system determined by latitude, longitude, and altitude. In this case, the first computing device 100 calculates the positions of the (first and second) predetermined points by appropriately performing coordinate conversion.

### Variation 2

The floating body (moving body) may be an object that floats in the air, such as an airplane or a drone. Furthermore, the vehicle oscillates due to vibrations while traveling or acceleration (forward/rearward or lateral acceleration) that occurs while traveling. Furthermore, the current position of these objects changes as they move. Furthermore, buildings also oscillate due to the effects of earthquakes or wind. Therefore, for example, the above-described embodiment can also be applied when calculating the positional relationship between an airplane (drone) or a vehicle and a building.

### Variation 3

In this embodiment, the first computing device 100 is directly connected to the first antenna 210, the second antenna 220, and the third antenna 230. In addition, the second computing device 300 is directly connected to the fourth antenna 410, the fifth antenna 420, and the sixth antenna 430. However, the connection with the antenna need not be limited to this example. In another example, the first computing device 100 (second computing device 300) may be indirectly connected to at least one of the first antenna 210, the second antenna 220, and the third antenna 230 (the fourth antenna 410, the fifth antenna 420, and the sixth antenna 430) via one or more external computers such as relay devices.

### Variation 4

In addition, the first computing device 100 may obtain the attitude of the ship 10 using an inertial measurement unit when the current position of at least one of the first antenna 210, the second antenna 220, and the third antenna 230 cannot be obtained. Here, the inertial measurement unit is mounted on a ship 10. Then, the first computing device 100 acquires the current position of the antenna whose current position can be acquired among the first antenna 210, the second antenna 220, or the third antenna 230, and modifies the first reference vector from the antenna to the first predetermined point according to the current attitude of the ship 10 at the current position of the antenna. The first computing device 100 may obtain the current position of the inertial measurement unit and correct the reference vector from the inertial measurement unit to a predetermined point. In this way, even in a situation where all three antennas on the ship 10 are unable to acquire the current position, the accurate position of the first predetermined point can be ascertained.

In addition, the second computing device 300 may also obtain the attitude of the power plant 30 using an inertial measurement unit when the current position of at least one of the fourth antenna 410, the fifth antenna 420, and the sixth antenna 430 cannot be obtained. Then, the second computing device 300 transmits to the first computing device 100 specific information including the current position of the antenna whose current position has been obtained, among the fourth antenna 410, the fifth antenna 420, and the sixth antenna 430, and the attitude of the power plant 30. In this way, even if the current position of all three antennas at the power plant 30 cannot be acquired, the exact position of the second predetermined point can be determined.

### Variation 5

In this embodiment, the first computing device 100 calculates the position of the second predetermined point using the fourth position, the fifth position, and the sixth position. As a result, even if the second computing device 300 does not have the function to calculate the position of the second predetermined point, the first computing device 100 can calculate the position of the second predetermined point and calculate the positional relationship between the first predetermined point and the second predetermined point. On the other hand, in this modified example, the second computing device 300 calculates the position of the second predetermined point using the fourth position, the fifth position, and the sixth position. In this case, the second computing device 300 calculates the position of the second predetermined point using the fourth position, the fifth position, and the sixth position, and then transmits specific information including the position to the first computing device 100. The first computing device 100, which has received the position of the second predetermined point, calculates the positional relationship between the first predetermined point and the second predetermined pointed using the calculated position of the first predetermined point and the received position of the second predetermined point. In this way, the first computing device 100 and the second computing device 300 each calculate the position of the predetermined point, so that the load on the first computing device 100 for calculating the position of the predetermined point can be reduced. Therefore, it is possible to accurately grasp the positional relationship between the ship 10 and the power plant 30 while shortening the calculation time for the position of a predetermined point.

### Variation 6

In this embodiment, the second computing device 300 transmits the current position of the power plant 30 to the first computing device 100 via satellite communication. However, the information that the second computing device 300 transmits to the first computing device 100 via satellite communication may include information indicating other than the current location of the power plant 30. The information that the second computing device 300 transmits to the first computing device 100 via satellite communication may include, for example, the positions of the fourth antenna 410, the fifth antenna 420, and the sixth antenna 430. In this case, the first computing device 100 may calculate the position of the second predetermined point in the power plant 30 using the method described above. Even in this manner, even if the first computing device 100 cannot communicate directly with the second computing device 300, the position of the second predetermined point can be calculated using information on the positions of each antenna of the power plant 30.

It should be noted that there may be a lag in the information on the positions of the antennas of the power plant 30 that the first computing device 100 receives via satellite communication. However, in this case, since there is a considerable distance between the ship 10 and the power plant 30, it is expected that the impact on safety will be small.

### OTHER EMBODIMENTS

The above-described embodiment is merely an example, and the present disclosure can be modified as appropriate without departing from the spirit and scope of the present disclosure. Furthermore, the processes and means described in this disclosure can be freely combined and implemented as long as no technical contradiction occurs.

Furthermore, the processes described as being performed by one device may be shared and executed by a plurality of devices. Alternatively, the processes described as being performed by different devices may be performed by a single device. In a computer system, the hardware configuration (server configuration) by which each function is realized can be flexibly changed.

The present disclosure can also be realized by supplying a computer program implementing the functions described in the above embodiments to a computer, and having one or more processors of the computer read and execute the program. Such a computer program may be provided to the computer by a non-transitory computer-readable storage medium connectable to the system bus of the computer, or may be provided to the computer via a network. A non-transitory computer-readable storage medium includes any type of medium suitable for storing electronic instructions, such as, for example, any type of disk, such as a magnetic disk (such as a floppy disk or a hard disk drive (HDD)), an optical disk (such as a CD-ROM, a DVD disk, or a Blu-ray disk), a read-only memory (ROM), a random-access memory (RAM), an EPROM, an EEPROM, a magnetic card, a flash memory, or an optical card.

What is claimed is:

1. A positioning system comprising a first module that acquires information for calculating a positional relationship between a first oscillating body and a target, a second module that acquires information for calculating a positional relationship between the first oscillating body and the target with higher accuracy than the first module, and a first computing device, wherein
the second module has a first communication device,
the first communication device is configured to be able to communicate directly with a second communication device attached to the target, and
the first computing device calculates the positional relationship between the first oscillating body and the target using the information acquired by the first module, when the first communication device and the second communication device are not within a range capable of direct communication, and
the first computing device calculates the positional relationship between the first oscillating body and the target using the information acquired by the second module, the information including specific information related to the position of the target received by the first communication device from the second communication device, when the first communication device and the second communication device are within a range capable of direct communication.

2. The positioning system according to claim 1, wherein
the second module is equipped with a first positioning antenna, a second positioning antenna, and a third positioning antenna, and
calculating the positional relationship between the first oscillating body and the target when the first communication device and the second communication device are within a range capable of direct communication includes,
acquiring a first position measured by the first positioning antenna, a second position measured by the second positioning antenna, and a third position measured by the third positioning antenna,
calculating a current attitude of the first oscillating body at the first position from a first vector from the first position to the second position and a second vector from the first position to the third position,
modifying a first reference vector from the first positioning antenna to a first predetermined point in the attitude of the first oscillating body at a predetermined time in accordance with the calculated current attitude of the first oscillating body at the first position,
calculating a position of the first predetermined point in the current attitude of the first oscillating body by adding the modified first reference vector to the first position, and
calculating a current positional relationship between the first predetermined point and the target by referring to the specific information.

3. The positioning system according to claim 2, wherein
the target is an oscillating body,
the target is equipped with a fourth positioning antenna, a fifth positioning antenna, and a sixth positioning antenna,
the specific information is information including a fourth position measured by the fourth positioning antenna, a fifth position measured by the fifth positioning antenna, and a sixth position measured by the sixth positioning antenna, and
calculating a positional relationship between the first oscillating body and the target when the first communication device and the second communication device are within a range capable of direct communication includes,
calculating a current attitude of the target at the fourth position from a third vector from the fourth position to the fifth position and a fourth vector from the fourth position to the sixth position, referring to the specific information,
modifying a second reference vector from the fourth positioning antenna to a second predetermined point in the attitude of the target at a predetermined time in accordance with the calculated current attitude of the target at the fourth position,
calculating a position of the second predetermined point in the current attitude of the target by adding the modified second reference vector to the fourth position, and
calculating a current positional relationship between the first predetermined point and the second predetermined point by referring to the positions of the first predetermined point and the second predetermined point.

4. The positioning system according to claim 2, wherein
the target is an oscillating body, and
the target includes a fourth positioning antenna, a fifth positioning antenna, and a sixth positioning antenna, and a second computing device, and
the second computing device configured to execute;
acquiring a fourth position measured by the fourth positioning antenna, a fifth position measured by the fifth positioning antenna, and a sixth position measured by the sixth positioning antenna,
calculating a current attitude of the target at the fourth position from a third vector from the fourth position to the fifth position and a fourth vector from the fourth position to the sixth position,
modifying a second reference vector from the fourth antenna to a second predetermined point in the attitude of the target at a predetermined time in accordance with the calculated current attitude of the target at the fourth point, and
calculating a position of the second predetermined point in the current attitude of the target by adding the modified second reference vector to the fourth point, and
the specific information includes the position of the second predetermined point calculated by the second computing device, and
calculating the positional relationship between the first oscillating body and the target when the first communication device and the second communication device are within a range capable of direct communication includes,
calculating a current positional relationship between the first predetermined point and the second predetermined point by referring to the position of the first predetermined point and the position of the second predetermined point included in the specific information.

5. The positioning system according to claim 1, wherein the first communication device and the second communication device perform direct communication via a wireless LAN.
